(19) United States
(12) Patent Application Publication
(10) Pub. No.: US 2008/0087749 A1
(43) Pub. Date: Apr. 17, 2008

(54) Irrigation flushing system

(76) Inventors: Rodney Ruskin, San Francisco, CA (US); Francois vanderSpuy, Napa, CA (US)

Correspondence Address: CHRISTIE, PARKER & HALE, LLP, PO BOX 7068, PASADENA, CA, 91109-7068, US

(21) Appl. No.: 11/546,021

(22) Filed: Oct. 10, 2006

(51) Int. Cl. B05B 15/00

(52) U.S. Cl. 239/542; 239/565; 239/575

(57) ABSTRACT

A water treatment and/or irrigation system which includes a source of water under pressure, such as a pump, an optional filter that receives water from the pump and emits filtered water under pressure, a system of irrigation lines that receives water under pressure for distribution to a field, and a flushing system for periodically cleaning the irrigation lines and/or the filter. The flushing system has a pressure vessel that receives the water under pressure and periodically builds its pressure to a level in excess of the normal level of the pressure delivered to the field, followed by discharging the built-up pressure as sharp pulses separated by one or more short time intervals directed toward the irrigation lines and/or the filter to effect cleaning thereof.

### FIELD OF THE INVENTION

This invention relates to irrigation systems, and more particularly, to a system and method for flushing irrigation systems, including drip irrigation lines, drip irrigation emitters, and filters used in irrigation systems.

### BACKGROUND

Irrigation systems need to be periodically flushed to remove foreign materials which may have accumulated in the tubes. In particular, drip irrigation systems need to be flushed particularly well, due to the small size of the flow paths in the emitters; and, drip irrigation systems used for effluent disposal and reuse need the maximum degree of flushing.

Anti-bacterial linings have been used in irrigation systems, including drip irrigation systems and in waste water disposal systems. These anti-bacterial linings can inhibit the growth of slime which occurs inside supply lines or drainage lines, especially in waste water disposal systems. Irrigation lines having such anti-bacterial linings are disclosed in U.S. Pat. No. 5,332,160 to Ruskin.

Lower cost products not containing the anti-bacterial lining are more commonly used for irrigation and waste water disposal and reuse. Because the build up of slime is inevitable in irrigation and waste water systems, the tubes need to be periodically cleaned to remove slime or other organic matter that accumulates. A common practice is to operate a flushing cycle that cleans or at least partially cleans the tubes, the drip irrigation emitters, filters and the like. U.S. Pat. No. 5,200,065 to Sinclair et al. discloses a turbulent flow system for flushing a dripper field, for example. According to The American Society of Agricultural and Biological Engineers flush velocity standards, a minimum flow velocity of 0.3 m/s (1 ft/s) is needed for flushing of lateral lines.

Generally speaking, there are three regimes of flow:
(1) Laminar flow, Reynolds no. less than 2000
(2) Unstable flow, Reynolds no. between 2000 and 3000
(3) Turbulent flow, Reynolds no. greater than 3000.
   Flushing a pipeline with a set or recommended velocity, such as 2 ft/sec, will not necessarily produce a turbulent or unstable flow. Pipe diameter and the resulting area of the flow path also are factors that determine the desired flushing necessary for cleaning the pipe wall.

As to the desired “scouring” effect for flushing pipelines, in some instances turbulent flow, depending on the Reynolds number, can produce a flow pattern at the wall interface which does not produce a scouring effect. According to the National Onsite Wastewater Recycling Association's Recommended Guidance for Design of Wastewater Drip Dispersal Systems, “scouring” is defined as the “process to clear a conduit of particulates by hydraulic flushing at a sufficient velocity to lift and carry particulates downstream.”

Present flushing technology consists of opening the ends of the dripper laterals and passing the water (or effluent) through the tubes. Sometimes the velocity of flow is designed to exceed a minimum standard, such as two feet per second, in order to achieve turbulent flow, and thereby to scour growth off the walls of the tube. In most cases, this flushing flow, turbulent or laminar, does not remove any foreign material from inside the emitter.

To offset the lack of an anti-bacterial lining, by flushing driplines with a high velocity—for example, two ft/sec as is recommended by some manufacturers—higher pump pressures are required. This requires substantial field and flushing pressure, leading to use of expensive filter/pump systems, sometimes including two filters and often two separate pumps. Furthermore, due to the frictional loss in the tubes at high velocities, it is necessary to use shorter laterals, resulting in higher costs for more supply and flush piping and installation labor.

All drip irrigation systems require filtration. Periodically, filters must be cleaned, either manually or automatically.

### SUMMARY OF THE INVENTION

This invention comprises an improved system and method of flushing irrigation system pipelines. The invention is particularly suitable for flushing drip irrigation pipelines. The invention in many cases will provide improved flushing of the emitters. The invention also can be used as a filter flushing device.

Briefly, one embodiment of the invention comprises a water treatment and/or irrigation system which includes a source of water under pressure such as a pump, an optional filter that receives water from the pump or other source of water under pressure and emits filtered water under pressure, and a system of irrigation lines that receives the water under pressure for distribution to a field. The irrigation lines comprise conventional irrigation pipelines and/or drip irrigation pipelines containing emitters. A flushing system periodically cleans the irrigation lines, the emitters and/or optionally the filter. The flushing system includes a pressure vessel or reservoir that receives the filtered water under pressure. The pressure vessel is adapted to periodically build its pressure to a level substantially in excess of a normal level of pressure in the water delivered to the field. This is followed by discharging the water under its built-up pressure as one or more sharp pulses directed toward the irrigation lines, the emitters and/or optionally the filter to effect cleaning of the conventional irrigation pipelines, the drip irrigation pipelines, the drip irrigation emitters, and/or optionally the filter.

The pressure build up is released as a high pressure shock substantially higher than normal operating pressure and at a flow rate substantially higher than turbulent flow that has been used in the past for cleaning drip irrigation lines or emitters, for example. This high pressure shock or pressure pulse, which can be delivered as a single shock impulse, or as a series of separate pulses separated by short time intervals, has been shown to produce greatly improved cleaning of irrigation lines, drip irrigation lines, drip emitters and filters.

An improvement provided by the present invention is a more effective flushing of driplines and drip emitters compared with prior art systems using turbulent flow for flushing. Flushing of filters also is improved, and system operations can be carried out with smaller and less expensive filter and pump systems.

These and other aspects of the invention will be more fully understood by referring to the following detailed description and the accompanying drawings.

### BRIEF DESCRIPTION OF THE DRAWINGS

FIG. 1 is a schematic diagram showing an example of a water treatment system or irrigation system with which the flushing device of this invention may be used.

FIG. 2 is a graph of net pump discharge versus total dynamic head illustrating various conditions of a pump of the type which can be used in the water treatment or irrigation system of this invention.

FIG. 3 is a schematic view illustrating a mechanically driven piston and cylinder illustrating an alternative form of a pressure vessel according to principles of this invention.

FIG. 4 is a schematic diagram showing a spring-loaded piston which is an alternate pressure vessel that may be used in the flushing system of this invention.

FIGS. 5 and 6 are schematic cross-sectional diagrams illustrating a commonly used pressure-compensating emitter which illustrates a type of drip irrigation device that can be cleaned by the flushing system of this invention.

FIG. 7 is an exploded assembly view illustrating components of a screen filter which can be cleaned by the flushing device of this invention.

FIG. 8 is a schematic diagram showing an alternative water treatment system or irrigation system using the flushing device of this invention.

FIG. 9A is a schematic diagram illustrating an alternative method for operating the flushing system of this invention; FIG. 9B is a schematic diagram illustrating a variation of the flushing system and operation method of FIG. 9A.

FIG. 10 is a schematic diagram showing an irrigation system using the flushing device of this invention and also illustrating locations of pressure gauges used in a system for producing test data showing comparative effects of the flushing system.

### DETAILED DESCRIPTION

It is common practice in the irrigation industry to flush pipes by opening the ends of the lines and allowing the water pressure to flush organic matter or other debris out of the system. The recommended flush velocity will vary over a wide range according to (1) the material to be flushed out, (2) the diameter of the tube, and (3) the qualities of the inside lining of the tubes. In some instances turbulent flow is recommended. High flush velocities may require either larger or more pumps than may be required for operating the system. This particularly applies for drip irrigation, because the flows through the drippers are relatively low, resulting in small operating flows and small pumps.

An objective of the present invention is to apply one or more short sharp pulses of flow followed by or interrupted by short periods of no flow. These pulses can be applied to produce a shock or supercharged flow that flushes out the debris in the system or cleans any part of the system which is designed to be cleaned by a flow of water.

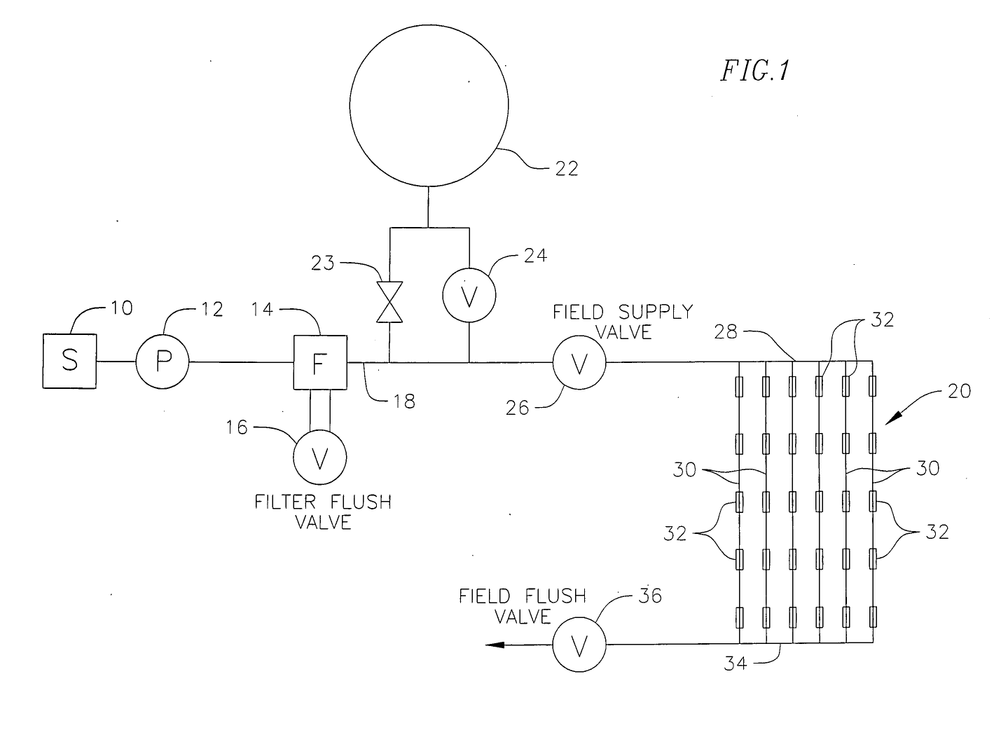

FIG. 1 is a schematic diagram illustrating a flushing system and method of this invention as applied to a system for treating and disposing of waste water. The FIG. 1 system is simply an example showing principles of this invention in a particular application. The invention also can be used for flushing irrigation systems generally, and in some cases, for flushing drip irrigation emitters. The invention also can be used as a filter flushing system. The invention also is described with respect to treatment and disposal of effluent from a treatment plant, however, the terms “effluent,” “waste water,” and “water” are used interchangeably herein to describe principles of the invention.

Referring to FIG. 1, a waste water treatment and disposal system includes a supply 10 of waste water to be treated, typically effluent from a treatment tank and a downstream dosing tank that feeds effluent to the waste water treatment system on demand. The waste water supply to the treatment system can be treated water from a septic tank or secondary or tertiary treated waste water effluent, for example. The effluent is supplied to a pump 12 which forces the effluent through a filter 14. Use of the pump 12 is one example as applied to the illustrated system. Alternatively, the water or other effluent can be supplied to the system by an external source of water under a supply pressure. The filter has a filter flush valve 16 that is normally closed during system operation, but the valve is opened when flushing the filter. The filter 14 is useful in the illustrated system, but the filter is an optional component. Other systems to which the invention may be applied, such as sprinkler systems, may not include a filter. The effluent passes from the filter through a flow line 18 leading to a dripper field 20. The effluent passing to the dripper field fills a pressure vessel 22. The pressure vessel can be any of several types of devices that contain filtered water under a normal operating pressure but are adapted to increase the pressure of the contained water on demand. The pressure vessel of FIG. 1 can be a bladder-type vessel in which the bladder is compressed to its operating pressure during normal operations in which the filtered effluent is sent to the dripper field. In one embodiment, the pressure vessel comprises a WELL-X-TROL 8.6 gallon hydro-pneumatic tank. This pressure vessel was used in experimental tests as described below.

With the pressure vessel 22 filled and the system operating at normal system pressure or pump pressure, the effluent passes through the supply line 18 to the dripper field. The line to the dripper field leading away from the pressure vessel includes a field supply valve 26. This valve is normally open during normal operation of the waste water treatment and disposal system.

The pressure vessel is connected to the flow line 18 through a check valve 23 and a control valve 24 which is normally closed during normal operation of the system and the pressure vessel will always pressurize through the check valve. In a system in which normal pump operating pressure is 30 psi, for example, pressure in the hydro-pneumatic tank is 30 psi. Then when pressurizing beyond operating pressure, the field supply valve 26 will close and pressure builds up in the pressure vessel 22 as the pump goes to or near a static flow condition.

In some instances, the control valve 24 is not needed. If the pressure in pressure vessel 22 is allowed to build to say 60 psi, and then immediately letting the surge flow (as described below) with valves 24 and 26 both open, then valve 24 is redundant to valve 26. However, if one wants to increase the pressure while performing other operations, such as turning off the pump in order to give the drippers (described below) an extra long draining time, without keeping the pump operating in a static condition for a longer time than necessary to bring vessel 22 to 60 psi, for example, then valve 24 is kept closed. Keeping valve 26 closed with valve 24 open would result in the surge going back through filter 14, pump 12 and into the supply source 10. When using the surge to clean the filter 14, as described below, a check valve (not shown) between the pump 12 and filter 14 can be useful to prevent the surge going back through the pump. The pump can be kept running during flushing of the filter, but there are configurations of filters where this may not be desirable.

The dripper field includes a supply manifold 28 having separate lateral rows of parallel drip irrigation lines 30 overlying the dripper field. Each of the dripper lines has spaced apart drip irrigation emitters 32 through which the treated effluent flows to the ground. The ends of the drip irrigation lines tie into a common return manifold and discharge line 34 leading to a field flush valve 36. This valve is normally closed during normal operation of the waste water treatment and disposal system. The field flush valve 36 can be opened for flushing the dripper field or at select time intervals for returning effluent back to an initial treatment tank.

The drip lines shown in FIG. 1 and the related manifolds and drippers are similar to a landscape system, for example, to which the flushing system also can be applied.

During normal operation, the pump 12 supplies water to the field. The field supply valve 26 is open, the control valve 24 for the pressure vessel is open, and the field flush valve 36 is closed. The bladder contained in the pressure vessel 22 is compressed to the operating pressure.

During flushing, the field supply valve 26 is initially closed and the field flush valve 36 is opened. (The pressure vessel control valve 24 remains open.) The pump builds pressure in the pressure vessel 22 to a pressure substantially in excess of normal pump pressure. At a preset pressure a pressure monitor (not shown) on the pressure vessel sends a control signal to open the field supply valve 26. A surge of water in the form of a pressure pulse is sent through the irrigation lines 30 in the field from the pressure vessel 22. The pressure in the pressure vessel is raised to a pressure level that can produce a sudden pressure pulse that produces a supercharged shock to the driplines 30 for cleaning the lines. The pressure in the pressure vessel drops, and at a preset low pressure level, the pressure monitor sends a control signal to close the field supply valve 36. The pressure in the pressure vessel then builds again, and a second pressure pulse can be generated. The cycle is repeated as often as may be required. At the end of the flushing cycle or cycles, the field flush valve 36 is closed and the field supply valve 26 is opened and normal operation is resumed.

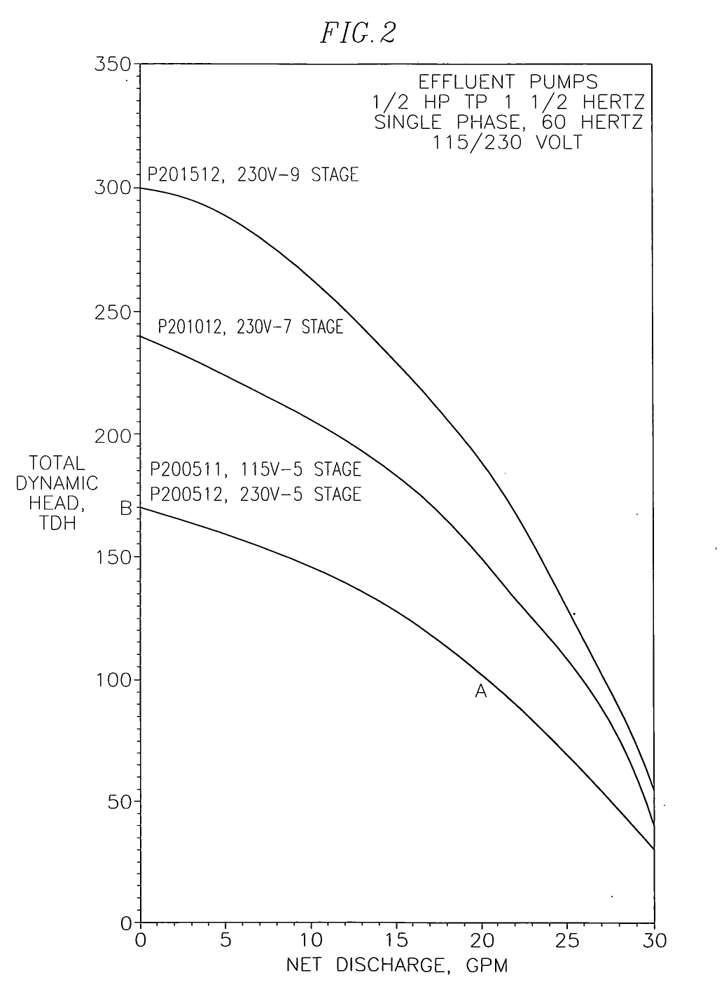

A high pressure surge or impulse is obtained due to the nature of almost all commonly used pump curves. Referring to FIG. 2, normal operating conditions may be at point A, i.e., 20 GPM at 100 feet dynamic head. When the field supply valve is closed then the flow to the field drops to zero and the pressure in the pressure vessel can build to point B, at say 170 feet dynamic head.

The pressure pulse generated by the flushing system of this invention is produced by allowing pressure to build up in the pressure vessel to a level well in excess of normal system operating pressure or pump operating pressure. In the embodiment in which normal system or pump operating pressure is 30 psi, the pressure is allowed to expand to more than about 50 psi, and more preferably about 60 psi. Recognizing that different system operating pressures or pump pressures and pressure reservoirs can be used, the flushing dynamic is generally effective by building pressure to at least about 50% more than normal system or pump operating pressure, followed by opening the field supply valve so as to immediately drop the reservoir pressure.

To clean the dripline emitters, as opposed to the driplines themselves, the flushing system is operated to drop the pressure at the emitter to zero and then reapply the pressure, thereby first allowing the rubber diaphragm in the emitter to move back from the outlet, followed by driving the diaphragm forward to expel any debris that may have lodged in the emitter. Both the field supply valve and the field flush valve are closed. The water in the field drains through the drippers and pressure drops to zero, at the same time that pressure in the pressure vessel expands to say 60 psi. Then the field supply valve is opened, causing a pressure surge in the driplines, ejecting foreign material from the drippers; This procedure can be repeated several times until normal field flow rates are restored.

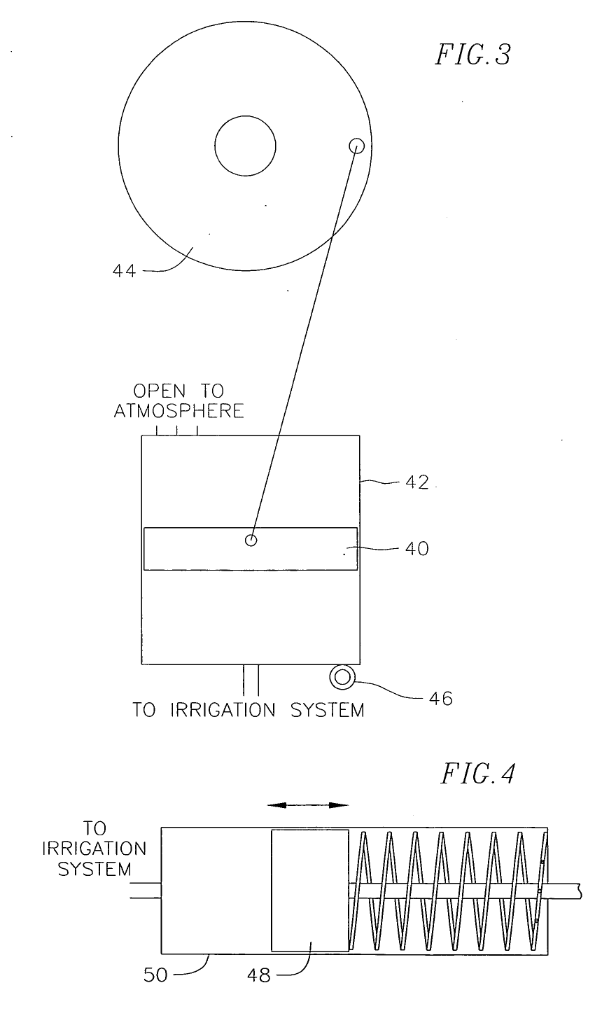

Many hydrodynamic pressure devices can generate a pressure surge as described above. For example, as is shown in FIG. 3, a mechanically driven piston 40, which draws water into the cylinder 42 and expels it a high pressure, can be used. Alternatively, a spring loaded piston 48 in a cylinder 50, as illustrated in FIG. 4, can be used. The cylinder is pushed back by the water pressure and provides the surge by means of the spring pressure. The invention is not limited to the method used to provide the surges of high pressure flow.

In the case of drip irrigation, surges of flush water may be an efficient way to clean some drip irrigation emitters. Drip emitters are manufactured in many different designs, and some can be cleaned effectively by the flushing system of this invention. A commonly used type of pressure compensating emitter is shown in FIGS. 5 and 6 This emitter is a type of pressure compensating emitter made by The Toro Company, El Cajon, Calif. and available from Geoflow, Inc., Corte Madera, Calif. This emitter contains a rubber diaphragm 52 which is deflected against the outlet 54 of the emitter by the internal water pressure. When the pressure is removed, the diaphragm springs back and leaves the outlet open. Then when the water pressure is again increased, the first short burst of water, before the diaphragm closes, flushes through the outlet, thereby cleaning out any debris in the dripper. A study by the Center of Irrigation Technology, has demonstrated that this type of dripper is efficiently cleaned by such a cycle of pressure off/pressure on. Cleaning is particularly improved using the pressure impulse system of this invention. Because these drippers are pressure compensating, the flow through the dripper is nearly constant at all practical pressures, and high velocity flushing of the drip irrigation supply line, such as by turbulent flow, will leave the diaphragm in its operating position, and will have no cleaning effect upon the dripper.

Another commonly used design of dripper (not shown) is known as a turbulent flow emitter. Such an emitter is also available from Geoflow, Inc. The flow in the emitter is proportional to the pressure. The alternating surges of pressure may dislodge some materials in the flow path. The cleaning of this type of emitter by the flushing system of this invention may be effective, but is not as effective as the pressure compensating example. If the main purpose of the surge is to clean the emitters, then the field flush valve can remain closed through the entire cycle and all the pressure and flow from the surge will be available for cleaning the emitters. Best results may be obtained by first cleaning the tubes with the field flush valve open, and then completing the cleaning of the emitters with the field flush valve closed.

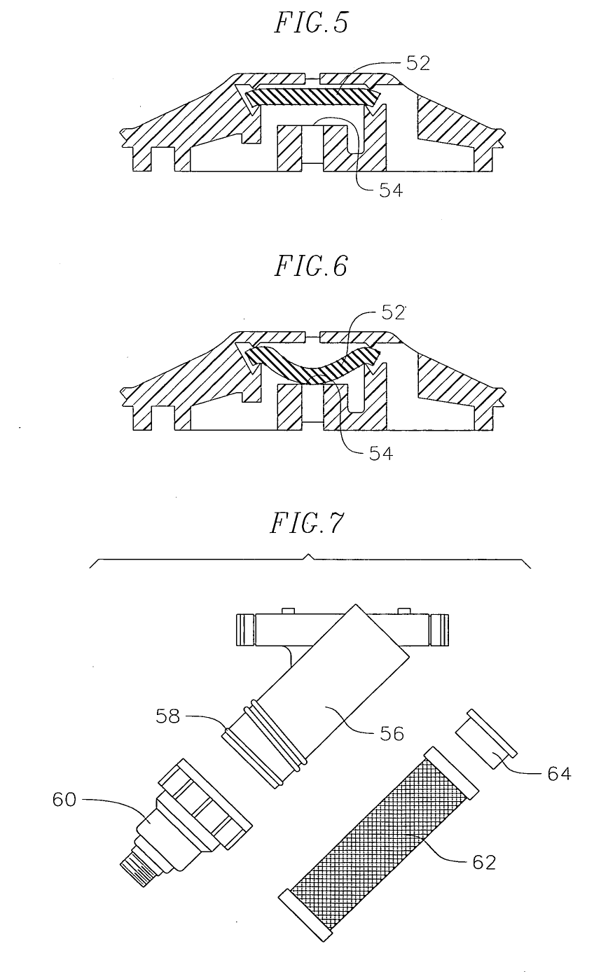

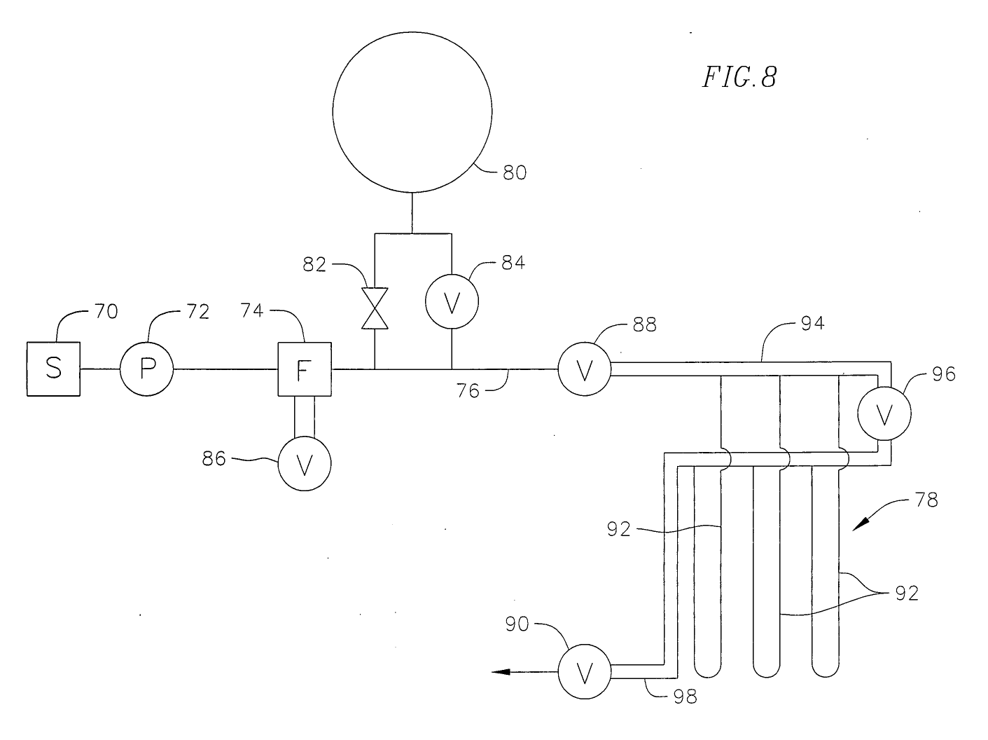

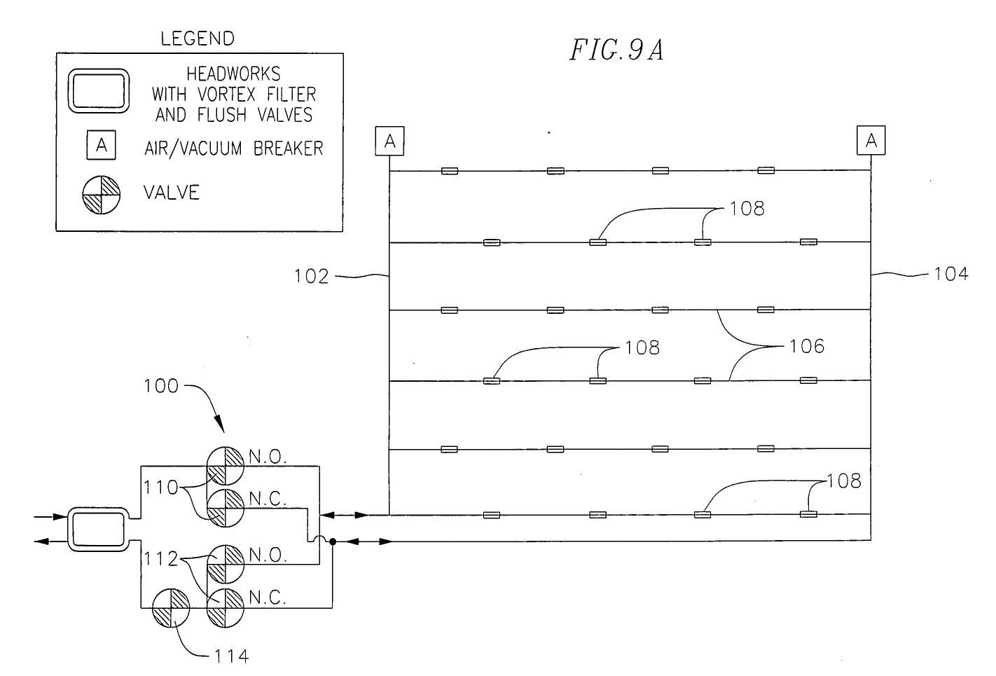

The system shown in FIG. 1 can be used for flushing the filter. An example of the filter is a normally forward flushing screen filter as shown in FIG. 7. The filter includes an upper housing 56, an O-ring 58, a debris basin 60, a screen 62 and a spin plate 64. By opening the filter flush valve and closing the field supply valve, the high pressure cleaning pulses can be applied to backflush through the screen of the filter. If the pump is left running flushing is both forward and backflushing simultaneously Under certain hydraulic conditions the field supply valve can stay open and the larger part of the surge will still pass backwards through the filter. There are many types of filters used in the irrigation and waste water treatment industries, and this technique will useful for some, but not for all. Another example of a filter which may be used with the invention is a disk filter such as the Arkal family of disk filters.

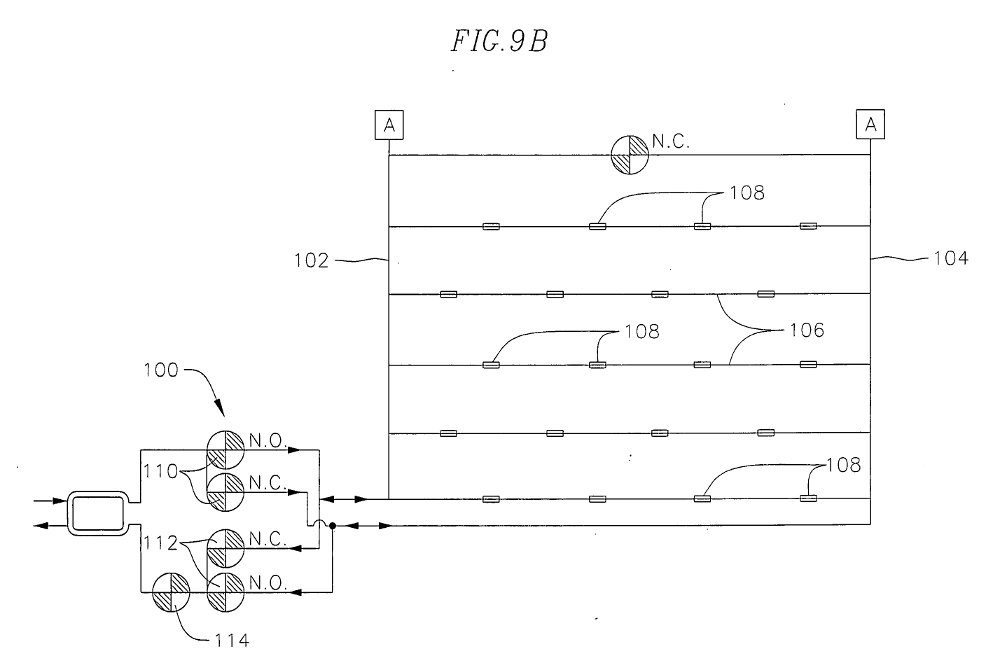

FIG. 8 is an alternative embodiment of the invention in which the flushing system is adapted for cleaning the manifolds connected to the dripline laterals in the field. This embodiment, which is similar to the FIG. 1 embodiment, includes the effluent supply 70, the pump 72, and a filter 74 for supplying filtered effluent through a supply line 76 to the field 78. A pressure vessel 80, which can be similar to the bladder type pressure vessel 22 described previously, is connected to the supply line through the check valve 82 and the control valve 84. The system of FIG. 8 also includes the filter flush valve 86, the field supply valve 88, and the field flush valve 90. Filtered effluent in the supply line 76 downstream from the pressure vessel 80 is sent to the driplines 92 in the field, through a supply manifold 94 having a flush valve 96 upstream from the driplines 92. The effluent passing from the driplines passes through a flushing manifold 98 and the field flush valve 90.

The system shown in FIG. 8 is adapted to clean the manifolds with or without the high pressure shock described previously. During normal operation in which the effluent is sent to the driplines, the pump stays running and the field supply valve 88 is open, the flush valve 96 is open, and the field flush valve 90 also is closed. This will allow the drip lines 92 to be filled from both ends, allowing a very fast and efficient fill time. For cleaning the manifolds without applying high pressure shock, the field supply valve 88 is open, and the flushing valves 96 and 98 are opened. The pump also can be operated at higher than normal pressure to produce a turbulent flow in the manifolds. This can produce a scouring effect in the manifolds. Alternatively, the high pressure shock can be applied to the manifolds by closing the field supply valve 88 to build pressure in the pressure vessel, while the valves 96 and 90 are opened. Opening the field supplyvalve 88 produces the high pressure shock for cleaning the manifolds.

There are two distinct flush cycles:
(1) Valve 88 will close for the full pressurization. Then valves 84, 88 and 90 will open simultaneously with valve 96 still open from the previous operating cycle. This can be referred to as the flush manifold flush cycle.
(2) Valve 88 will close to re-pressurize the vessel, and then with valves 84, 88 and 90 open and valve 96 closed, the drip lateral flush will occur.

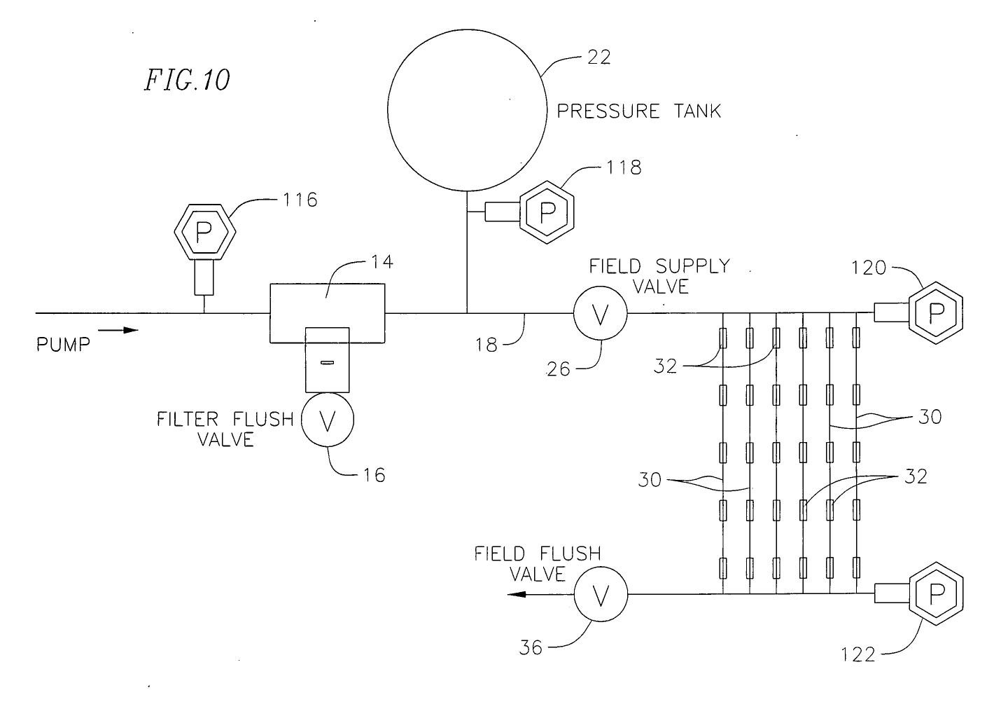

FIG. 9A illustrates an alternative form of the invention having an alternating 4-valve system 100 for controlling the direction of flushing flow through the driplines and the manifolds. This embodiment is similar to those described previously in which filtered effluent passes through the supply line past the pressure vessel or other reservoir that builds up pressure. This embodiment includes the usual arrangement of the supply manifold 102, the return manifold 104, and the driplines 106 with their drip irrigation emitters 108. The four-alternating valve system includes a first pair of valves 110 and a second pair of valves 112 which in one cycle are in the normally open or normally closed positions as shown in FIG. 9A. The field flush valve 114 also is shown in its normal position downstream from the dripper field and the return manifold 104. This system can be used to alternate the flush and supply manifold functions: With the valves set in their normally open and normally closed positions as shown in FIG. 9A, flushing takes place from left to right in FIG. 9A in its normal manner. All four valves are then switched simultaneously to an alternative cycle in which flushing takes place from right to left with reference to FIG. 9A. Because water is normally lost down the dripperline through the drippers, the velocity at the supply end is much more rapid than at the flushing end. Therefore, alternating the direction of the flushing ensures that the whole pipe is subjected to maximum flush velocity. This flushing cycling can be combined with the hydrodynamic tank or other high pressure impulse system as described previously so as to provide a vigorous cleaning action. Alternatively, the four alternating valves can be replaced by two 3-way valves.

FIG. 9B combines the systems and methods of operation of FIGS. 8 and 9A. The backward and forward flushing as illustrated in FIG. 9A could in some circumstances result in an excessive build-up of material in the manifolds, which then can be flushed according to the method of FIG. 8

### EXAMPLE

An irrigation and pressure flushing system as shown in FIG. 10 was constructed and operated to test the pressure flushing system of this invention. Comparative tests were conducted to show the results of operating the irrigation and flushing system at normal operating conditions using flushing at a rate of two feet per second to produce turbulent flow through the driplines, compared with using the pressure shock system of this invention to apply high pressure pulses greatly in excess of normal pump operating pressure. The test system was set up with four pressure gauges to measure pressure at different locations in the system. The illustrated test system included a pressure gauge 116 for measuring pump pressure, a pressure gauge 118 for measuring pressure in the pressure tank 22, a pressure gauge 120 for measuring the pressure of filtered effluent passing through the field supply manifold in the driplines, and a pressure gauge 122 in the field flush manifold to measure pressure in the return line downstream from the driplines.

The pump was normally run at 30 psi. For the high pressure shock test, the pump with a normal operating pressure of 30 psi generated 60 psi in the pressure chamber, followed by opening the field supply valve. Test results are shown in the attached Appendix. These tests involved primarily a set of field flush tests in which the filter flush valve remained closed and the field supply and field flush valves were opened. Filter flush tests also were conducted with the field supply valve closed and the field supply valve open, as indicated in the test results. As for the field flush tests, comparative tests were conducted to measure flow rate in the driplines for high pressure shock tests compared to normal pump operating conditions. For each set of comparative tests as shown in the test results, the top row indicates the flushing flow rate in feet per second compared with the second row which shows the flushing flow rate under normal pump operating conditions. These comparative tests show that the high pressure in excess of normal operating pressure provided by the present invention in each case produced substantially greater field flushing flow rates than flushing conducted under normal operating conditions, absent the high pressure flushing pulses.

What is claimed is:

1. A water treatment and/or irrigation system comprising: a source of water under pressure such as a pump, an optional filter that receives water from the source of pressure and emits water under pressure, a system of irrigation lines that receives the water under pressure for distribution to a field, the irrigation lines comprising conventional irrigation pipelines and/or drip irrigation pipelines containing emitters, and a flushing system for periodically cleaning the irrigation lines and/or optionally the filter, the flushing system having a pressure vessel that receives the water under pressure for distribution to the field and is adapted to periodically build its pressure to a level in excess of a normal level of pressure in the water delivered to the field, followed by discharging the built-up pressure as one or more sharp pressure pulses directed toward the irrigation lines or optionally the filter to effect cleaning of the conventional irrigation pipelines, the drip irrigation pipelines, the drip irrigation emitters, and/or optionally the filter.

2. Apparatus according to claim 1 in which the pressure vessel comprises a hydro-pneumatic tank containing an internal expandable reservoir that can expand to build pressure from incoming water under pressure.

3. Apparatus according to claim 1 in which the pressure vessel comprises a piston and cylinder providing a reservoir and a device coupled to the piston to expand the pressure applied to incoming water under pressure.

4. Apparatus according to claim 1 including a field supply valve between the pressure vessel and the irrigation lines in the field, and in which the field supply valve in a closed position causes the periodic build up of pressure in the pressure vessel.

5. Apparatus according to claim 4 including a field flush valve downstream from the irrigation lines, and in which the field flush valve is closed during normal operation and is open when flushing the irrigation lines.

6. Apparatus according to claim 1 in which the pressure build up in the pressure vessel that produces the pressure pulse is at least about 50% higher than normal system or pump operating pressure.

7. Apparatus according to claim 1 in which the irrigation lines include a supply manifold and a return manifold, and including a valve in a line that causes preferential flow to the manifolds, owing to their diameter being larger than the diameter of the irrigation lines, the valve adapted to receive the pressure pulse for use in cleaning the manifolds.

8. Apparatus according to claim 1 including a set of alternating valves adapted to produce forward flow or reverse flow for the irrigation lines.

9. A drip irrigation and/or effluent disposal system comprising: a source of water under pressure such as a pump, an optional filter that receives water from the source of pressure and emits water under pressure, a system of irrigation lines that receives the water under pressure for distribution to a field, the irrigation lines comprising drip irrigation pipelines containing emitters, and a flushing system for periodically cleaning the irrigation lines and/or the emitters, the flushing system including a pressure reservoir that receives the water under pressure for distribution to the field and is adapted to periodically build its internal pressure to a level in excess of a normal level of pressure in the water delivered to the field, and a field supply valve that controls the flow of water from the pressure reservoir to the drip irrigation lines, for use in discharging the built-up pressure as one or more sharp pulses directed toward the drip irrigation lines to effect cleaning of the irrigation pipelines and/or the drip irrigation emitters.

10. Apparatus according to claim 9 in which the pressure vessel comprises a hydro-pneumatic tank containing an internal expandable reservoir that can expand to build pressure from incoming water under pressure.

11. Apparatus according to claim 9 in which the pressure vessel comprises a piston and cylinder providing a reservoir and a device coupled to the piston to expand the pressure applied to incoming water under pressure.

12. Apparatus according to claim 9 including a field flush valve downstream from the irrigation lines, and in which the field flush valve is closed during normal operation and is open when flushing the irrigation lines.

13. Apparatus according to claim 9 in which the pressure build up in the pressure vessel that produces the pressure pulse is at least about 50% higher than normal system or pump operating pressure.

14. A method of flushing a water treatment and/or irrigation system comprising: providing a source of water under normal system operating pressure, an optional filter that receives the water under pressure and optionally emits filtered water, a system of irrigation lines that receives the water under pressure for distribution to a field, the irrigation lines comprising conventional irrigation pipelines and/or drip irrigation pipelines containing emitters, and a flushing system for periodically cleaning the irrigation lines and/or optionally the filter, the flushing system having a pressure vessel that receives the water under pressure for distribution to the field and causing the vessel to periodically build its pressure to a level in excess of a normal level of pressure in the water delivered to the field, followed by discharging the built-up pressure as one or more sharp pressure pulses directed toward the irrigation lines or optionally the filter to effect cleaning of the conventional irrigation pipelines, the drip irrigation pipelines, the drip irrigation emitters and/or optionally the filter.

15. The method according to claim 14 including a field supply valve between the pressure vessel and the irrigation lines in the field, and including cycling the field supply valve between a closed position which causes the periodic build up in pressure in the pressure vessel and an open position which causes the sharp pressure pulses.

16. The method according to claim 14 including closing a supply valve in the field to cause the pressure build up in the pressure vessel, and in which the pressure in the pressure vessel builds to at least 50% higher than normal system or pump operating pressure to produce the pressure pulse.
